(19) United States
(12) Patent Application Publication
(10) Pub. No.: US 2012/0182714 A1
(43) Pub. Date: Jul. 19, 2012

(54) COMPOSITE FILM FOR LIGHT-EMITTING APPARATUS, LIGHT-EMITTING APPARATUS AND METHOD FOR PRODUCING THE COMPOSITE FILM

(75) Inventors: Sunghoon KWON, Seoul (KR); Sueun Chung, Seoul (KR); Seungah Lee, Yeoju-gun (KR); Jisung Jang, Seoul (KR); Sangkwon Han, Incheon (KR)

(73) Assignee: SNU R&DB FOUNDATION, Seoul (KR)

(21) Appl. No.: 13/432,515

(22) Filed: Mar. 28, 2012

Related U.S. Application Data
(63) Continuation of application No. PCT/KR2010/006580, filed on Sep. 28, 2010.

(30) Foreign Application Priority Data
Sep. 28, 2009 (KR) 10-2009-0091441

(51) Int. Cl. F21V 9/16; B05D 5/06; B05D 1/18; G02B 5/02

(52) U.S. Cl. 362/84; 359/599; 427/157

(57) ABSTRACT

Provided is a composite film used for a light emitting apparatus including a light emitting device. The composite film includes a fluorescent layer including phosphors and an optical plate disposed on the fluorescent layer, and diffusing, reducing or mixing at least one of light emitted by the light emitting device, light emitted by the phosphors and a combination thereof.

### CROSS-REFERENCE TO RELATED APPLICATION(S)

The present application claims priority to Korean patent application number 10-2009-0091441, filed on Sep. 28, 2009, which is incorporated by reference in its entirety.

### BACKGROUND

The present invention generally relates to a light emitting apparatus, and more specifically, to a composite film used for a light emitting apparatus, a light emitting apparatus and a method of fabricating the same.

Recently, a light emitting device such as a light emitting diode (LED) that has emerged as a leading next-generation light source has been widely used for electronic appliances, remote controllers, jumbotron boards, etc. to display and transmit signals. In particular, developments in an LED device emitting the three primary colors of light, i.e., red, green and blue, have led to active research into an LED to be used as a light source.

When a high-brightness LED light source is used for lighting to replace a conventional incandescent lamp or fluorescent lamp, energy efficiency is significantly increased and lifespan is lengthened, so that costs incurred in replacement are reduced. Further, since it is resistant to vibration and impact, and does not require use of a toxic material such as mercury, it is very advantageous in terms of energy conservation, environmental protection, and reduction in cost.

### SUMMARY

One aspect of the present invention provides a composite film used for a light emitting apparatus including a light emitting device. The composite film includes a fluorescent layer including phosphors, and an optical plate disposed on the fluorescent layer, and diffusing, reducing or mixing at least one of light emitted by the light emitting device, light emitted by the phosphors and a combination thereof.

Another aspect of the present invention provides a composite film used for a light emitting apparatus including a light emitting device. The composite film includes an optically transparent polymer film including phosphors. The polymer film includes an optical pattern diffusing, reducing or mixing at least one of light emitted by the light emitting device, light emitted by the phosphors and a combination thereof on a surface thereof.

Still another aspect of the present invention provides a method of fabricating a composite film used for a light emitting apparatus including a light emitting device. The method of fabricating a composite film includes providing a fluorescent layer including phosphors, and forming an optical pattern diffusing, reducing or mixing at least one of light emitted by the light emitting device, light emitted by the phosphors and a combination thereof.

Yet another aspect of the present invention provides a method of fabricating a composite film used for a light emitting apparatus including a light emitting device. The method of fabricating a composite film includes providing an optically transparent polymer including phosphors and forming an optically transparent polymer film having a surface on which an optical pattern is formed using the optically transparent polymer and a mold on which the optical pattern is formed. The optical pattern diffuses, reduces or mixes at least one of light emitted by the light emitting device, light emitted by the phosphors and a combination thereof.

Yet another aspect of the present invention provides a light emitting apparatus. The light emitting apparatus includes a substrate including at least one light emitting device disposed on a surface thereof, and a composite film disposed to be spaced apart from the light emitting device, and including phosphors and an optical pattern. The optical pattern diffuses, reduces or mixes at least one of light emitted by the light emitting device, light emitted by the phosphors and a combination thereof.

Yet another aspect of the present invention provides a method of fabricating a light emitting apparatus. The method of fabricating a light emitting apparatus includes providing a substrate including at least one light emitting device disposed on a surface thereof, and combining a composite film including phosphors and an optical pattern with the substrate.

The above description is provided to introduce a selection of concepts in a simplified form that are described in greater detail below. This is not intended to identify key features or essential features of the claimed subject matter, nor is it intended to be used as an aid in limiting the scope of the claimed subject matter.

### BRIEF DESCRIPTION OF THE DRAWINGS

The above and other features and advantages of the present disclosure will become more apparent to those of ordinary skill in the art by describing in detail example embodiments thereof with reference to the attached drawings in which:

FIG. 1 is a view of a composite film used for a light emitting apparatus including a light emitting device according to one exemplary embodiment of the present invention;

FIGS. 2 to 6 are views of a fluorescent layer in various forms used for the composite film 100 of FIG. 1 according to one exemplary embodiment;

FIG. 7 is a view of a composite film used for a light emitting apparatus including a light emitting device according to another exemplary embodiment;

FIG. 8 is a view of a composite film used for a light emitting apparatus including a light emitting device according to still another exemplary embodiment;

FIG. 9 is a view of a composite film used for a light emitting apparatus including a light emitting device according to yet another exemplary embodiment;

FIG. 10 is a flowchart illustrating a method of fabricating a composite film used for a light emitting apparatus including a light emitting device;

FIG. 11 is a view illustrating a. method of fabricating a composite film according to one exemplary embodiment;

FIG. 12 is a view illustrating a method of fabricating a composite film including a fluorescent layer and an optical pattern according to another exemplary embodiment;

FIG. 13 is a view illustrating a process of forming at least one phosphor layer 1150 on a substrate 1120 according to one exemplary embodiment;

FIG. 14 is a view illustrating a process of forming at least one phosphor layer 1150 on a substrate 1120 according to another exemplary embodiment;

FIG. 15 is a view illustrating a process of forming at least one phosphor layer 1150 on a substrate 1120 according to still another exemplary embodiment;

FIG. 16 is a flowchart illustrating a method of fabricating a composite film used for a light emitting apparatus including a light emitting device according to yet another exemplary embodiment;

FIG. 17 is a view illustrating a method of fabricating a composite film used for a light emitting apparatus including a light emitting device according to yet another exemplary embodiment;

FIG. 18 is a view of a light emitting apparatus according to one exemplary embodiment;

FIG. 19 is a view illustrating a method of fabricating a light emitting apparatus to according to one exemplary embodiment;

FIG. 20 is a view illustrating a method of fabricating a light emitting apparatus according to another exemplary embodiment; and

FIG. 21 is a view illustrating a method of fabricating a light emitting apparatus according to still another exemplary embodiment.

### DETAILED DESCRIPTION

Hereinafter, exemplary embodiments of the present invention will be described in detail. Unless otherwise specified in the specification, like reference numerals designate like elements throughout the specification. However, the present invention is not limited to the embodiments disclosed in the detailed description of the invention, drawings and claims, other embodiments may be employed, and can be implemented in various modified forms without departing from the scope of the present invention. One of ordinary skill in the art could have easily understood that the element of the disclosure, i.e., the element generally described herein and disclosed in the drawings could have been variously disposed, configured, combined and designed, all of these are clearly taken into account, and they partially constitute the disclosure.

It will be understood that when an element is referred to as “surrounding” another element, it can directly surround the other element or intervening additional elements may be present therebetween.

Also, it will be understood that when an element is referred to as “being disposed” on another element or another element is referred to as “being disposed” on an element, it can be directly disposed on the other element or intervening additional elements may be present therebetween.

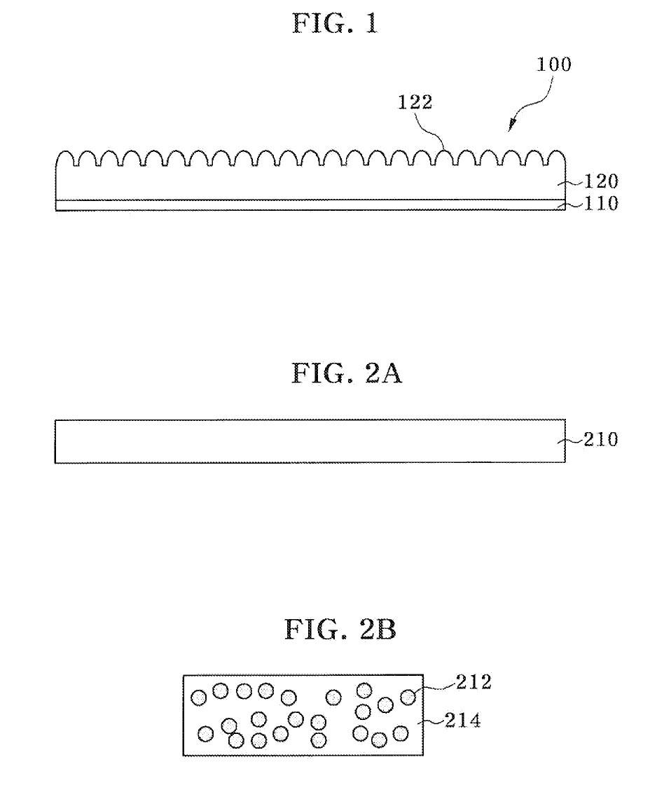

FIG. 1 is a view of a composite film used for a light emitting apparatus including a light emitting device according to one exemplary embodiment of the present invention. Referring to FIG. 1, a composite film 100 includes a fluorescent layer 110 and an optical plate 120.

The fluorescent layer 110 includes phosphor particles (hereinafter referred to as a “phosphor,” not shown). The fluorescent layer 110 may be in various forms. In the drawing, an optically transparent polymer film in which phosphors are dispersed is illustrated as an example of the fluorescent layer 110. The optically transparent polymer film in which phosphors are dispersed may be obtained by curing an optically transparent polymer in which phosphors are dispersed. The optically transparent polymer may be a photo or thermally cured polymer. In another exemplary embodiment, unlike the illustrated drawing, the fluorescent layer 110 may include at least one phosphor layer (not shown). The at least one phosphor layer may be a collection of a plurality of phosphors of the same type. Alternatively, the at least one phosphor layer may be a collection of at least two different types of phosphors. In still another exemplary embodiment, unlike the illustrated drawing, the fluorescent layer 110 may include at least one phosphor layer (not shown) and at least one optically transparent polymer film (not shown). The phosphor layer and the polymer film may be disposed in various manners. For example, the phosphor layer and the polymer film may be alternately disposed. The example is for the purpose of understanding and is not intended to exclude various possible dispositions other than the above example. In yet another exemplary embodiment, unlike the illustrated drawing, the fluorescent layer 110 may include at least one first optically transparent polymer film in which at least one phosphor is dispersed and at least one second optically transparent polymer film. The first optically transparent polymer film and the second optically transparent polymer film may be disposed in various manners. For example, the first optically transparent polymer film and the second optically transparent polymer film may be disposed alternately. The example is for the purpose of understanding and is not intended to exclude various possible dispositions other than the above example.

Various types of phosphors may be used as the, phosphors. For example, the phosphors may be formed of at least one selected from a red phosphor, a green phosphor, a blue phosphor, a yellow phosphor and a combination thereof depending on an emitted color. Also, the phosphors may be formed of at least one selected from an organic phosphor, an inorganic phosphor, a nano phosphor, a quantum dot phosphor and a combination thereof. Further, a phosphor refers to a luminescent material that absorbs energy in a form of light, electricity, etc., from the outside and emits light of its own wavelength. Light of various colors may be implemented depending on a color of external light provided to the fluorescent layer 110 including the phosphors and type of the phosphors. Moreover, even if external light of a certain color is provided to the fluorescent layer 110, when the type or mixture of the phosphors included in the fluorescent layer 110 is changed, light of various colors may be implemented. That is, even if external light of a certain color is provided, a color temperature may be adjusted by changing the type or mixture of the phosphors. The color temperature indicates that the color change of emitted light, which is shown depending on temperature, is stated in absolute temperature, Kelvin (K), based on the white color. The external light may be, for example, light provided by a light emitting device such as an LED. The example is for the purpose of understanding, and various light emitting devices such as a semiconductor laser or an organic light emitting diode (OLED) may be used as the light emitting device. In one exemplary embodiment, when an ultraviolet (UV) LED is used as the external light and the fluorescent layer 110 includes a red phosphor, red light may be implemented. In another exemplary embodiment, when a red LED is used as the external light, and the fluorescent layer 110 includes a green phosphor, yellow light may be implemented. In still another exemplary embodiment, when a blue LED is used as the external light and the fluorescent layer 110 includes red and green phosphors, white light may be implemented. In yet another exemplary embodiment, when a blue LED is used as the external light, and the fluorescent layer 110 includes a yellow phosphor, white light may be implemented. In yet another exemplary embodiment, when a UV LED is used as the external light, and the fluorescent layer 110 includes red, green and blue phosphors, white light may be implemented.

The optical plate 120 is disposed on the fluorescent layer 110, and diffuses, reduces or mixes at least one of light emitted by the light emitting device, light emitted by the phosphor and a combination thereof. An optical pattern 122 may be formed on a surface of the optical plate 120. The optical pattern 122 may include at least one selected from at least one convex lens, at least one concave lens, and a combination thereof. At least one convex lens is illustrated as an example of the optical pattern 122 in the drawing. Various kinds of materials may be used as the optical plate 120. An optically transparent material may be used as an example of the optical plate 120. An optically transparent polymer may be an example of the optically transparent material. The example is for the purpose of understanding and is not intended to exclude various possible materials other than the above example. Light provided to the optical plate 120 may be diffused by the convex lens. Also, the light provided to the optical plate 120 may be reduced by the concave lens. Further, the light provided to the optical plate 120 may be mixed in various forms by various combinations of the convex lens and the concave lens.

FIGS. 2 to 6 are views of a fluorescent layer in various forms used for the composite film 100 of FIG. 1 according to one exemplary embodiment.

Referring to FIG. 2, a fluorescent layer 210 may be an optically transparent polymer film 214 in which phosphors 212 are dispersed. Each of FIGS. 2A and 2B is a cross-sectional view of the fluorescent layer 210, and an enlarged view of the fluorescent layer 210. A fluorescent layer 210 in which phosphors 212 of the same type are dispersed is illustrated as an example in the drawing. In another exemplary embodiment, unlike the illustrated drawing, the fluorescent layer 210 may be an optically transparent polymer film 210 in which phosphors (not shown) of at least two different types or sizes are dispersed.

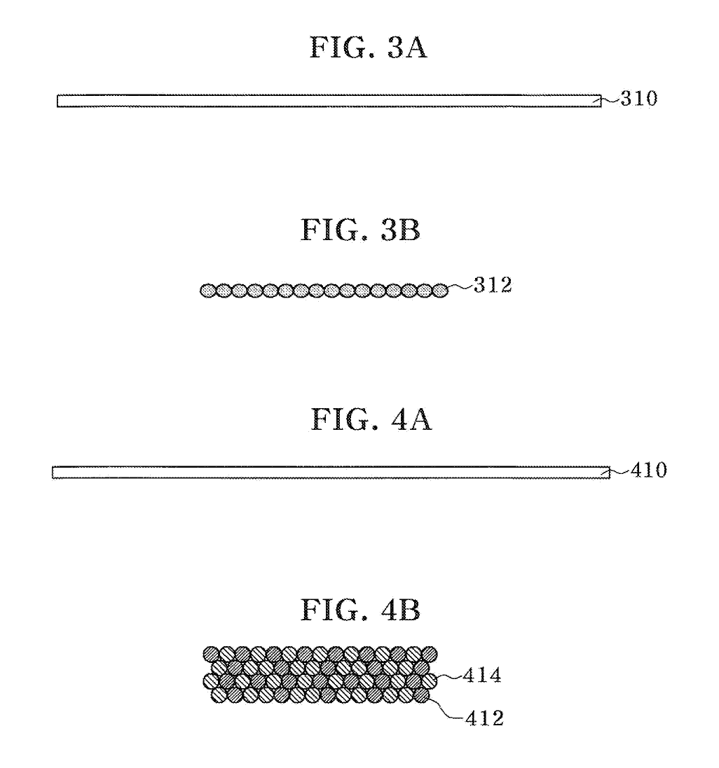

Referring to FIG. 3, a fluorescent layer 310 may be a phosphor layer. Each of FIGS. 3A and 3B is a cross-sectional view of the fluorescent layer 310, and an enlarged view of the fluorescent layer 310. A fluorescent layer 310 including phosphors 312 of the same type and size is illustrated as an example of the fluorescent layer 310 in the to drawing. In another exemplary embodiment, unlike the illustrated drawing, the fluorescent layer 310 may include phosphors of at least two different types or sizes.

Referring to FIG. 4, a fluorescent layer 410 may be a plurality of phosphor layers. Each of FIGS. 4A and 4B is a cross-sectional view of the fluorescent layer 410, and an enlarged view of the fluorescent layer 410. A fluorescent layer 410 including four phosphor layers is illustrated as an example of the fluorescent layer 410 in the drawing. In another exemplary embodiment, unlike the illustrated drawing, the fluorescent layer 410 may include various numbers of phosphor layers. Also, a fluorescent layer 410 including two different types of phosphors 412 and phosphors 414 is illustrated as an example in the drawing. In still another exemplary embodiment, unlike the illustrated drawing, the fluorescent layer 410 may include phosphors (not shown) of the same type. In yet another exemplary embodiment, unlike the illustrated drawing, the fluorescent layer 410 may further include at least one additional phosphor (not shown) different from the phosphors 412 and the phosphors 414. Further, a phosphor layer including two different types of the phosphors 412 and the phosphors 414 is illustrated as an example of the phosphor layer in the drawing. In yet another exemplary embodiment, unlike the illustrated drawing, the phosphor layer may include phosphors of the same type. In this case, in yet another exemplary embodiment, at least two of the plurality of phosphor layers may include different types of phosphors. When external light is applied to the fluorescent layer 410, as the number of phosphor layers included in the fluorescent layer 410 is increased, intensity of light excited by phosphors is increased. A frequency of the excitation light may be different from that of the external light. That is, when a concentration of the phosphors included in the fluorescent layer 410 is increased, intensity of excitation light excited by the fluorescent layer 410 is increased. Likewise, when a concentration of the phosphors included in the fluorescent layer 410 is reduced, intensity of excitation light excited by the fluorescent layer 410 is reduced. The external light and the excitation light may be diffused, reduced or mixed by the optical pattern 122 described with reference to FIG. 1. Therefore, when external light is applied to the fluorescent layer 410, the number of phosphor layers included in the fluorescent layer 410 may be adjusted to determine a finally obtained color or color temperature. The concentration of the phosphors may be adjusted by adjusting the number of phosphor layers or the concentration of phosphors included in each phosphor layer. As a result, light having various colors or color temperatures may be obtained from the external light applied to the fluorescent layer 410.

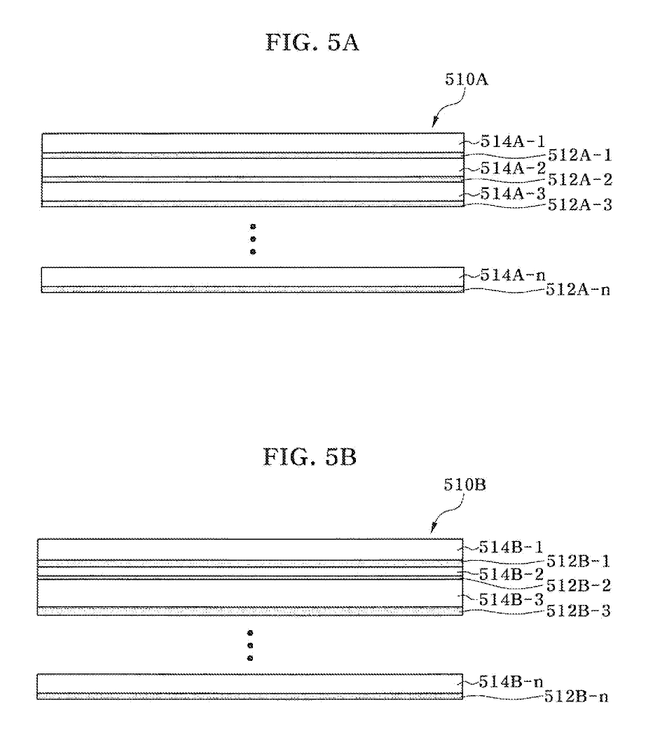

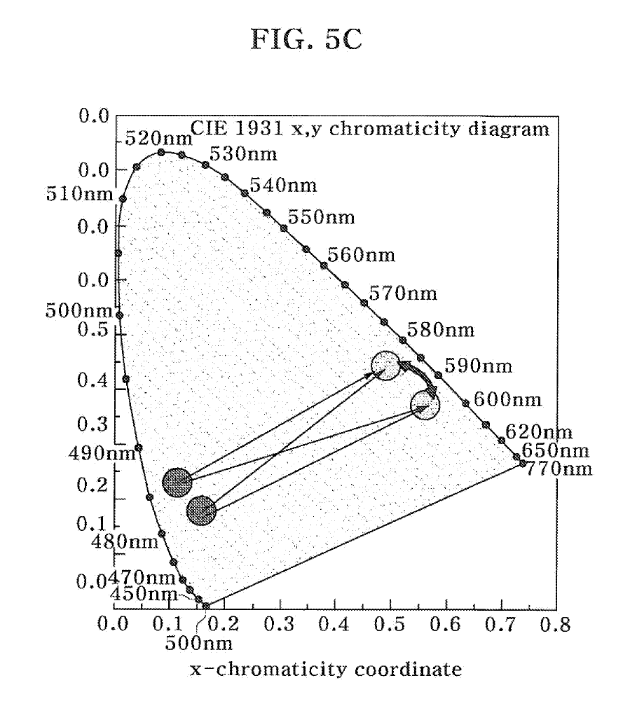

Referring to FIG. 5, a fluorescent layer may include at least one phosphor layer and at least one optically transparent polymer film. Each of FIGS. 5A and 5B is a cross-sectional view of a fluorescent layer 510A and a fluorescent layer 510B. FIG. 5C is a view illustrating various white lights obtained by changing compositions of the fluorescent layer 510A and the fluorescent layer 510B.

Referring to FIG. 5A, the fluorescent layer 510A may include at least one phosphor layer and at least one optically transparent polymer film. A fluorescent layer 510A including phosphor layers 512A-1, 512A-2, . . . and 512A-n, wherein n denotes a natural number, and optically transparent polymer films 514A-1, 514A-2, . . . and 514A-n that are alternately disposed is illustrated as an example of the fluorescent layer 510A in the. drawing. In another exemplary embodiment, unlike the illustrated drawing, the phosphor layers 512A-1, 512A-2, . . . and 512A-n and the optically transparent polymer films 514A-1, 514A-2, . . . and 514A-n may be disposed in various manners. Each of the phosphor layers 512A-1, 512A-2, . . . and 512A-n may be a single phosphor layer or a plurality of phosphor layers. Each of the phosphor layers 512A-1, 512A-2, . . . and 512A-n may have substantially the same structure as the phosphor layer or the plurality of phosphor layers included in the fluorescent layer 310 or the fluorescent layer 410 described with reference to FIG. 3 or 4. In still another exemplary embodiment, unlike the illustrated drawing, the fluorescent layer 510A may further include at least one optically transparent polymer film (not shown) in which phosphors are dispersed. The at least one optically transparent polymer film in which phosphors are dispersed may have substantially the same structure as the fluorescent layer 210 described with reference to FIG. 2. The polymer film in which phosphors are dispersed, the phosphor layers 512A-1, 512A-2, . . . and 512A-n and the optically transparent polymer films 514A-1, 514A-2, . . . and 514A-n may be disposed in various manners. As an example of the polymer film in which phosphors are dispersed, the phosphor layers 512A-1, 512A-2, . . . and 512A-n and the optically transparent polymer films 514A-1, 514A-2, . . . and 514A-n may be alternately disposed. The example is for the purpose of understanding and is not intended to exclude various possible dispositions other than the above example. In yet another exemplary embodiment, unlike the illustrated drawing, each of the phosphor layers 512A-1, 512A-2, . . . and 512A-n may be replaced by the optically transparent polymer film in which phosphors are dispersed. In this case, the fluorescent layer 510A may be disposed in various manners as described above. Further, optically transparent polymer films 514A-1, 514A-2, . . . and 514A-n formed to the same thickness are illustrated as the example in the drawing. In another exemplary embodiment, unlike the illustrated drawing, at least two of the optically transparent polymer films 514A-1, 514A-2, . . . and 514A-n may have different heights. In still another exemplary embodiment, at least two of the phosphor layers 512A-1, 512A-2, . . . and 512A-n, may have different compositions or different heights. As described with reference to FIG. 4, when external light is applied to the fluorescent layer 510A, the number of the phosphor layers 512A-1, 512A-2, and 512A-n or a concentration of the phosphors included in each of the phosphor layers 512A-1, 512A-2, . . . and 512A-n may be adjusted to determine a finally obtained color or color temperature.

Referring to FIG. 5B, the fluorescent layer 510B may include at least one phosphor layer and at least one optically transparent polymer film. A fluorescent layer 510B including phosphor layers 512B-1, 512B-2, . . . and 512B-n and optically transparent polymer films 514B-1, 514B-2, . . . and 514B-n that are alternately disposed is illustrated as an example of the fluorescent layer 510B in the drawing. As illustrated in the drawing, at least two of the optically transparent polymer films 514B-1, 514B-2, . . . and 514B-n may have different heights. In another exemplary embodiment, at least two of the phosphor layers 512B-1, 512B-2, . . . and 512B-n may have phosphors of different compositions or different heights.

Since the structures, functions, dispositions and features of the fluorescent layer 510B, the phosphor layers 512B-1, 512B-2, . . . and 512B-n and the optically transparent polymer films 514B-1, 514B-2, . . . and 514B-n are substantially the same as those of the fluorescent layer 510A, the phosphor layers 512A-1, 512A-2, . . . and 512A-n and the optically transparent polymer films 514A-1, 514A-2, . . . and 514A-n described with reference to FIG. 5A, the detailed description thereof will be omitted for convenience.

Referring to FIG. 5C, the above-described fluorescent layers 510A and 510B may be used to obtain white light having various color temperatures. In one exemplary embodiment, a blue LED may be used as external light, and the fluorescent layers 510A and 510B including only yellow phosphors may be used. In this case, intensity of the blue LED light or a concentration of the yellow phosphors may be adjusted to obtain white light. In FIG. 5C, white light that is present at the corner where a blue point having a wavelength of about 480 nm to about 490 nm is turned into a yellow point having a wavelength of about 580 nm to 600 nm can be obtained. In another exemplary embodiment, a blue LED may be used as external light, and the fluorescent layers 510A and 510B including various phosphors may be used. The phosphors included in the fluorescent layers 510A and 510B may be formed of one selected from a red phosphor, a green phosphor, a blue phosphor, a yellow phosphor and a combination thereof. In this case, when the intensity of the blue LED light and a concentration or composition of the phosphors are adjusted, various white lights that are present at the corner where a blue point is turned into a yellow point can be obtained as described with reference to FIG. 5C. A CIE plot of FIG. 5C is used to describe the above, and the above disclosure is not limited to the CIE plot. The example is for the purpose of understanding and is not intended to exclude light of various colors or color temperatures from being obtained by singly using external light (e.g., an LED) of various colors or phosphors of various types or a combination thereof.

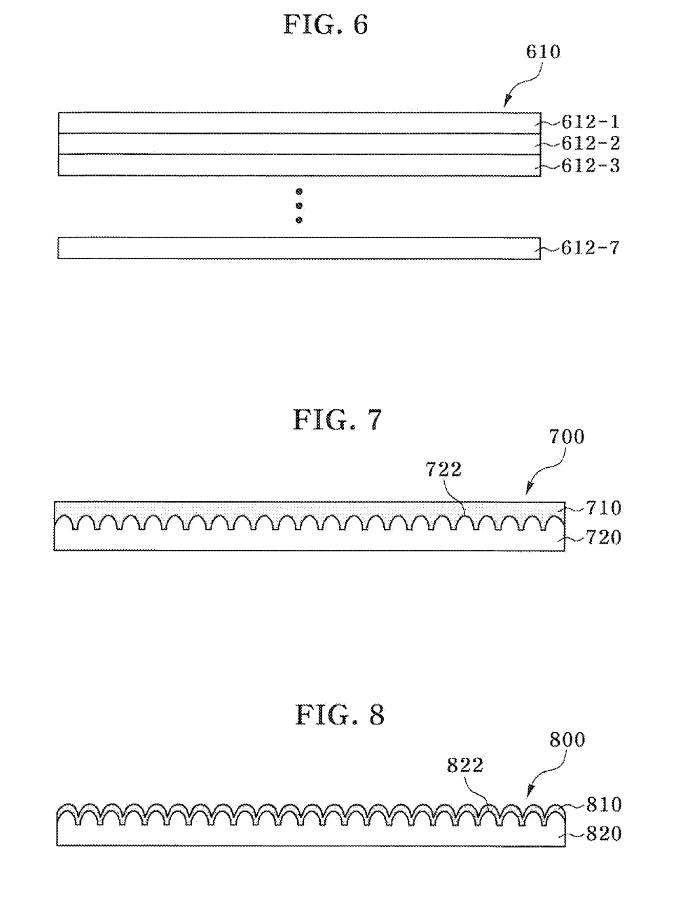

Referring to FIG. 6, a fluorescent layer 610 may be a plurality of optically transparent polymer films 612-1, 612-2, . . . and 612-n in which phosphors are dispersed. Each of the plurality of optically transparent polymer films 612-1, 612-2, . . . and 612-n may have substantially the same structure as the fluorescent layer 210 described with reference to FIG. 2. In another exemplary embodiment, unlike the illustrated drawing, the fluorescent layer 610 may further include at least one phosphor layer (not shown). The phosphor layer may have substantially the same structure as the phosphor layer or the plurality of phosphor layers included in the fluorescent layer 310 or the fluorescent layer 410 described with reference to FIG. 3 or 4. The fluorescent layer 610 may exhibit the various dispositions described with reference to FIG. 5. A plurality of optically transparent polymer films 612-1, 612-2, . . . and 612-n in which phosphors are dispersed and which have the same thickness are illustrated as an example in the drawing. In another exemplary embodiment, unlike the illustrated drawing, at least two optically transparent polymer films in which phosphors are dispersed of the plurality of optically transparent polymer films 612-1, 612-2, . . . and 612-n in which phosphors are dispersed may have different heights. In still another exemplary embodiment, at least two of the plurality of optically transparent polymer films 612-1, 612-2, . . . and 612-n in which phosphors are dispersed may have phosphors of different compositions. The function of the plurality of optically transparent polymer films 612-1, 612-2, . . . and 612-n in which phosphors are dispersed is substantially the same as the fluorescent layers 510A and 510B described with reference to FIG. 5, and thus the detailed description thereof will be omitted for convenience. As described with reference to FIGS. 4 or 5, when external light is applied to the fluorescent layer 610, the number of the plurality of optically transparent polymer films 612-1, 612-2, . . . and 612-n or a concentration of phosphors included in each of the optically transparent polymer films 612-1, 612-2, . . . and 612-n maybe adjusted to determine a finally obtained color or color temperature.

FIG. 7 is a view of a composite film used for a light emitting apparatus including a light emitting device according to another exemplary embodiment. Referring to FIG. 7, a composite film 700 includes a fluorescent layer 710 and an optical plate 720.

Referring to FIG. 7, different from the fluorescent layer 110 described with reference to FIG. 1, a fluorescent layer 710 is disposed on an optical pattern 722. The optical pattern 722 is substantially the same as the optical pattern 122 described with reference to FIG. 1. Since the structure, material and function of the fluorescent layer 710 and the optical plates 720 are substantially the same as those of the fluorescent layer 110 and the optical plate 120 described with reference to FIG. 1, the detailed description thereof will be omitted for convenience.

FIG. 8 is a view of a composite film used for a light emitting apparatus including a light emitting device according to still another exemplary embodiment. Referring to FIG. 8, a composite film 800 includes a fluorescent layer 810 and an optical plate 820.

Referring to FIG. 8, unlike the fluorescent layer 110 described with reference to FIG. 1, the fluorescent layer 810 is disposed on an optical pattern 822. Also, unlike the fluorescent layer 710 described with reference to FIG. 7, the fluorescent layer 810 is disposed along an optical pattern 822 on the optical plate 820. The optical pattern 822 is substantially the same as the optical pattern 122 described with reference to FIG. 1. Since the structure, material and function of the fluorescent layer 810 and the optical plate 820 are substantially the same as those of the fluorescent layer 110 and the optical plate 120 described with reference to FIG. 1, the detailed description thereof will be omitted for convenience.

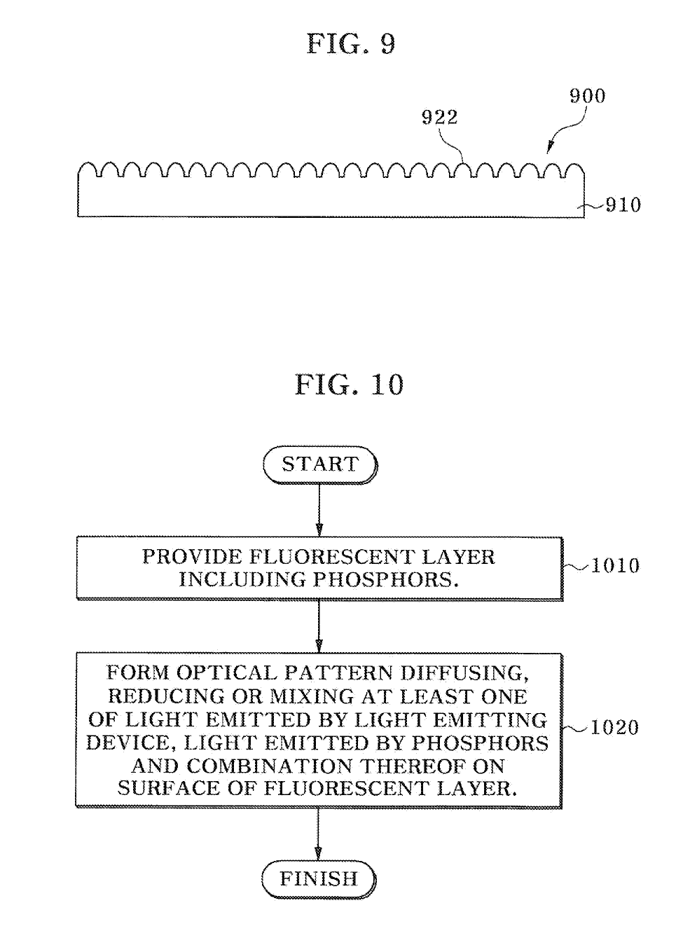

FIG. 9 is a view of a composite film used for a light emitting apparatus including a light emitting device according to yet another exemplary embodiment. Referring to FIG. 9, a composite film 900 includes an optically transparent polymer film 910 including phosphors (not shown). An optical pattern 922 diffusing, reducing or mixing at least one of light emitted by the light emitting device, light emitted by the phosphors and a combination thereof is disposed on a surface of the optically transparent polymer film 910 including phosphors.

The optically transparent polymer film 910 may include phosphors of the same type. In another exemplary embodiment, the optically transparent polymer film 910 may include at least two different phosphors. The optical pattern 922 may include at least one selected from at least one convex lens, at least one concave lens, and a combination thereof. An optical pattern 922 including at least one convex lens is illustrated as the optical pattern 922 in the drawing. The example is for the purpose of understanding and is not intended to exclude various possible dispositions of the optical pattern 922 other than the above example. Light provided to the optical pattern 922 may be diffused, reduced or mixed depending on the shape of the optical pattern 922. For example, when a convex lens is used as the optical pattern 922, the light provided to the optical pattern 922 may be diffused by the convex lens. In another exemplary embodiment, when a concave lens is used as the optical pattern 922, the light provided to the optical pattern 922 may be reduced by the concave lens. In still another exemplary embodiment, when a combination of a convex lens and a concave lens is used as the optical pattern 922, the light provided to the optical pattern 922 may be mixed in various manners by various combinations of the convex lens and the concave lens.

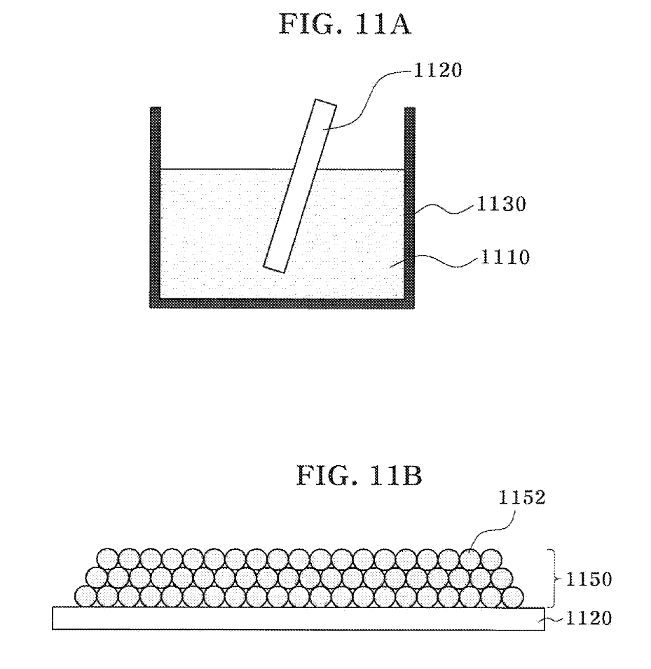

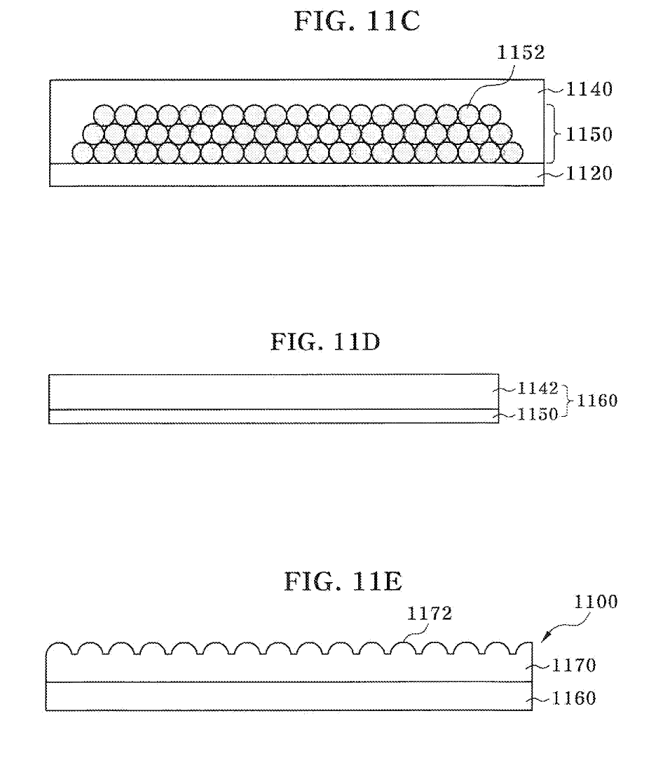

FIG. 10 is a flowchart illustrating a method of fabricating a composite film used for a light emitting apparatus including a light emitting device according to one exemplary embodiment. Referring to FIG. 10, a method of fabricating a composite film begins at block 1010. In block 1010, a fluorescent layer including phosphors is provided. In one exemplary embodiment, in the process of providing the fluorescent layer, the fluorescent layer includes an optically transparent polymer film in which at least one phosphor layer is formed on a surface of the fluorescent layer or an optically transparent polymer film in which phosphors are dispersed. In another exemplary embodiment, the process of providing the fluorescent layer includes providing a solution in which the phosphors are dispersed and a substrate, forming at least one phosphor layer on the substrate using at least one of dip coating, sedimentation, Langmuir-Blodgett deposition, template coating and a combination thereof and casting an optically transparent polymer on the phosphor layer. In still another exemplary embodiment, the process of providing the fluorescent layer includes providing a solution in which the phosphors are dispersed and a polymer film, and forming at least one phosphor layer on the polymer film using at least one of dip coating, sedimentation, Langmuir-Blodgett deposition, template coating and a combination thereof. In block 1020, an optical pattern diffusing, reducing or mixing at least one of light emitted by the light emitting device, light emitted by the phosphors and a combination thereof is formed on a surface of the fluorescent layer. In one exemplary embodiment, the process of forming the optical pattern includes a process of forming an optical plate on the surface of the fluorescent layer. The optical pattern is formed on a surface of the optical plate. In another exemplary embodiment, the process of forming the optical pattern includes forming the optical pattern on the surface of the fluorescent layer using a mold. A method of fabricating a composite film used for a light emitting apparatus including a light emitting device according to one exemplary embodiment will be described with reference to FIGS. 11 to 15.

FIG. 11 is a view illustrating a method of fabricating a composite film according to one exemplary embodiment. A composite film includes a fluorescent layer and an optical pattern. FIGS. 11A to 11D are views illustrating a method of fabricating a fluorescent layer, and FIG. 11E is a view illustrating a process of fabricating a composite film from the fabricated fluorescent layer.

Referring to FIG. 11A, a substrate 1120 is immersed in a solution 1110 in which phosphors are dispersed. Various types of solutions may be used as the solution 1110. An example of the solution 1110 may include distilled water, ethanol, isopropyl alcohol, etc. Various types of substrates may be used as the substrate 1120. An example of the substrate 1120 may include a glass substrate, a semiconductor substrate, a ceramic substrate, a metal substrate, a plastic substrate, etc. A process of immersing the substrate 1120 in a container 1130 receiving the solution 1110 in which phosphors are dispersed is illustrated as an example in the drawing. In another exemplary embodiment, unlike the illustrated drawing, the substrate 1120 may be immersed in the solution 1110 in various manners.

Referring to FIG. 11B, the substrate 1120 is taken out of the solution 1110 to form at least one phosphor layer 1150 on the substrate 1120. Three phosphor layers 1150 formed on the substrate 1120 are illustrated as an example in the drawing. In another exemplary embodiment, unlike the illustrated drawing, various numbers of phosphor layers may be formed on the substrate 1120. Also, the phosphor layers 1150 including phosphors 1152 of the same type are illustrated as an example in the drawing. In another exemplary embodiment, unlike the illustrated drawing, the phosphor layers 1150 may include at least two different types of phosphors (not shown). The structure and function of the phosphor layers 1150 may be substantially the same as those of the phosphor layer or the plurality of phosphor layers included in the fluorescent layer 310 or the fluorescent layer 410 described with reference to FIGS. 3 or 4.

Referring to FIG. 11C, an optically transparent polymer 1140 is cast on the at least one phosphor layer 1150 formed on the substrate 1120. The optically transparent polymer 1140 may be a photo or thermally cured polymer.

Referring to FIG. 11D, at least one phosphor layer 1150 and an optically transparent polymer film 1142 are separated from the substrate 1120 to obtain a fluorescent layer 1160 including phosphors. The optically transparent polymer film 1142 corresponds to a cured optically transparent polymer 1140. For example, the optically transparent polymer 1140 is cured by UV light to form the optically transparent polymer film 1142. In another exemplary embodiment, the optically transparent polymer 1140 may be thermally cured to form the .optically transparent polymer film 1142.

Referring to FIG. 11E, an optical plate 1170 is combined with a surface of the fluorescent layer 1160 including the phosphors to form a composite film 1100. An optical pattern 1172 diffusing, reducing or mixing at least one of light emitted by the light emitting device, light emitted by the phosphors and a combination thereof is disposed on a surface of the optical plate 1170. The optical pattern 1172 may include at least one, selected from at least one convex lens, at least one concave lens and a combination thereof. An optical pattern including at least one convex lens is illustrated as an example of the optical pattern 1172 in the drawing. The example is for the purpose of understanding and is not intended to exclude various possible dispositions of the optical pattern other than the above example. The optical plate 1170 may be fabricated in various manners. For example, the optical plate 1170 may be fabricated by casting an optically transparent polymer film on a mold on which the optical pattern 1172 is engraved. Since the optical plate 1170 is substantially the same as the optical plate 120 described with reference to FIG. 1, the detailed description thereof will be omitted for convenience.

Referring again to FIG. 11, when an optically transparent polymer film 1120 is used as the substrate 1120, the process of FIG. 11C may be omitted. In this case, the fluorescent layer 1160 may be formed of the phosphor layer 1150 and the optically transparent polymer film 1120. The optical plate 1170 is combined with the fluorescent layer 1160 to form a composite film 1100.

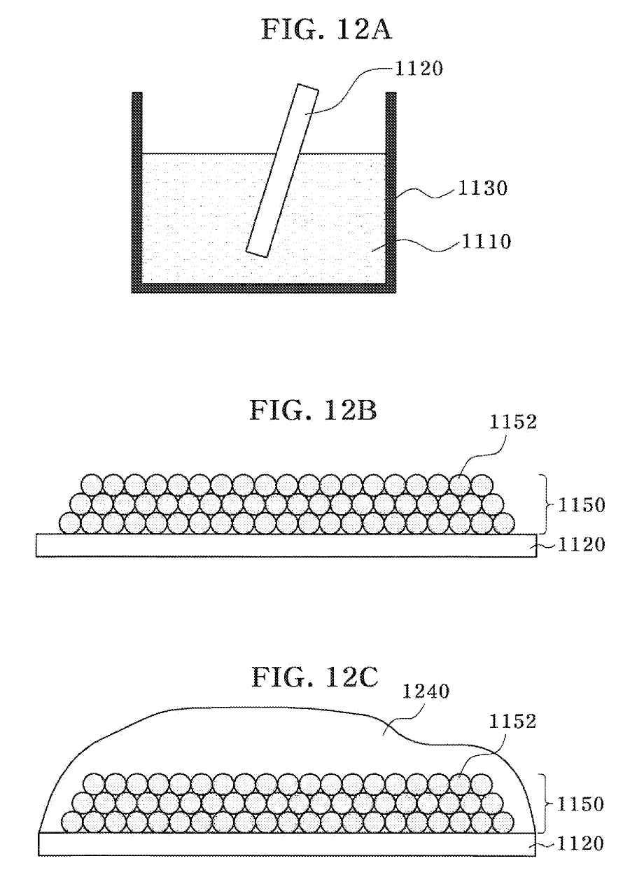

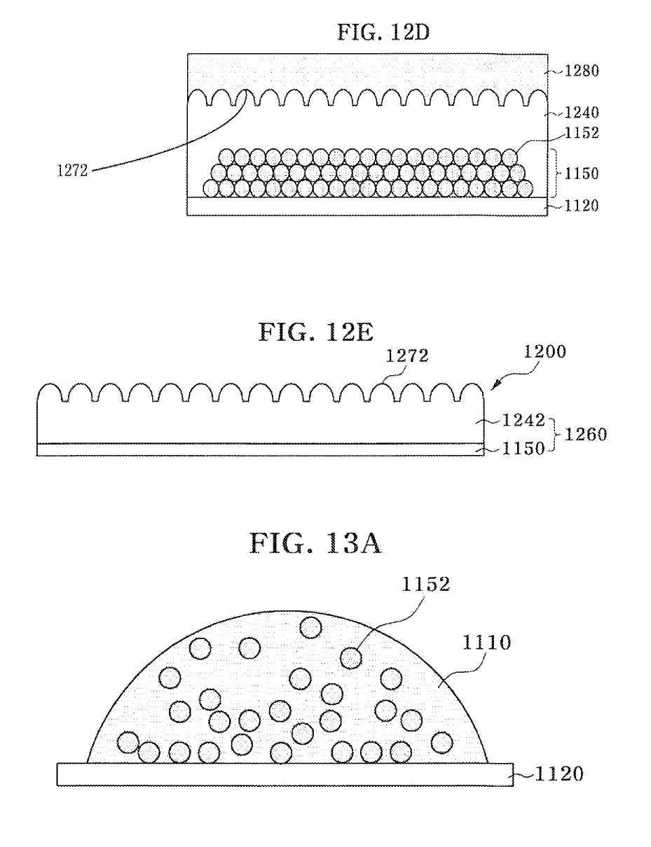

FIG. 12 is a view illustrating a method of fabricating a composite film according to another exemplary embodiment.

Since processes of FIGS. 12A and 12B are substantially the same as those of FIGS. 11A and 11B, the detailed description thereof will be omitted for convenience.

Referring to FIG. 12C, an optically transparent polymer 1240 is cast on at least one phosphor layer 1150 formed on a substrate 1120. Since the optically transparent polymer 1240 is substantially the same as the optically transparent polymer 1140 described with reference to FIG. 11C, the detailed description thereof will be omitted for convenience.

Referring to FIG. 12D, an optical pattern 1272 is formed on a surface of the optically transparent polymer 1240 using a mold 1280 on which the optical pattern 1272 is engraved. Various kinds of materials may be used as the mold 1280. A polymer film on which the optical pattern 1272 is engraved may be an example of the mold 1280.

Referring to FIG. 12E, the mold 1280 is separated to obtain a fluorescent layer 1260 including phosphors. The fluorescent layer 1260 includes at least one phosphor layer 1150 and an optically transparent polymer film 1242. The optically transparent polymer film 1242 corresponds to a cured optically transparent polymer 1240. For example, the optically transparent polymer 1240 is cured by UV light to form the optically transparent polymer film 1242. As another example, the optically transparent polymer 1240 may be thermally cured to form the optically transparent polymer film 1242. The optical pattern 1272 is formed on a surface of the optically transparent polymer film 1242. In this case, the fluorescent layer 1260 may perform functions of the composite film 1200.

Referring to FIGS. 11 and 12, as a result of processes of FIGS. 11A to 11C or processes of FIGS. 12A to 12C, each fluorescent layer 1160 and 1260 including at least one phosphor layer 1150 formed on a surface thereof may be obtained as each fluorescent layer 1160 and 1260. In another exemplary embodiment, unlike the illustrated drawing, the processes of FIGS. 11A to 11C or the processes of FIGS. 12A to 12C may be replaced by a process of forming an optically transparent polymer including phosphors directly on the substrate 1120. In this case, an optically transparent polymer film in which phosphors are dispersed may he obtained as the fluorescent layer. An example of the method of forming the optically transparent polymer on the substrate 1120 may include spin coating. The example is for the purpose of understanding and is not intended to exclude various possible formation methods other than the above example.

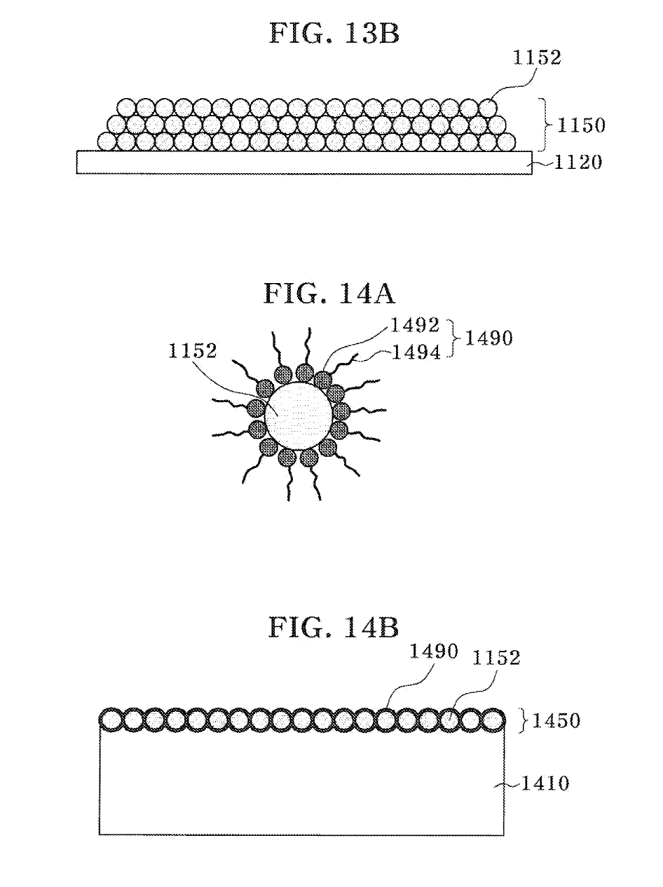

Referring again to FIGS. 11 and 12, as a result of processes of 11A and 11B or processes of FIGS. 12A and 12B, the at least one phosphor layer 1150 may be formed on the substrate 1120. The process of forming the at least one phosphor layer 1150 on the substrate 1120 may be achieved in various manners. The process of forming at least one phosphor layer 1150 on the substrate 1120 will be described below with reference to FIGS. 13 to 15. The subsequent processes performed following the above processes are substantially the same as processes of FIGS. 11C to 11E or processes of FIGS. 12C to 12E, the detailed description thereof will be omitted for convenience.

FIG. 13 is a view illustrating a process of forming at least one phosphor layer 1150 on a substrate 1120 according to one exemplary embodiment.

Referring to FIG. 13A, a solution 1110 in which phosphors 1152 are dispersed is formed on the substrate 1120.

Referring to FIG. 13B, the solution 1110 is evaporated to form at least one phosphor layer 1150 on the substrate 1120. The phosphors 1152 in the solution 1110 are deposited on the substrate 1120 to form the at least one phosphor layer 1150. When the processes of FIG. 13A and 13B are repeated, the height of the phosphor layer 1150 may be adjusted.

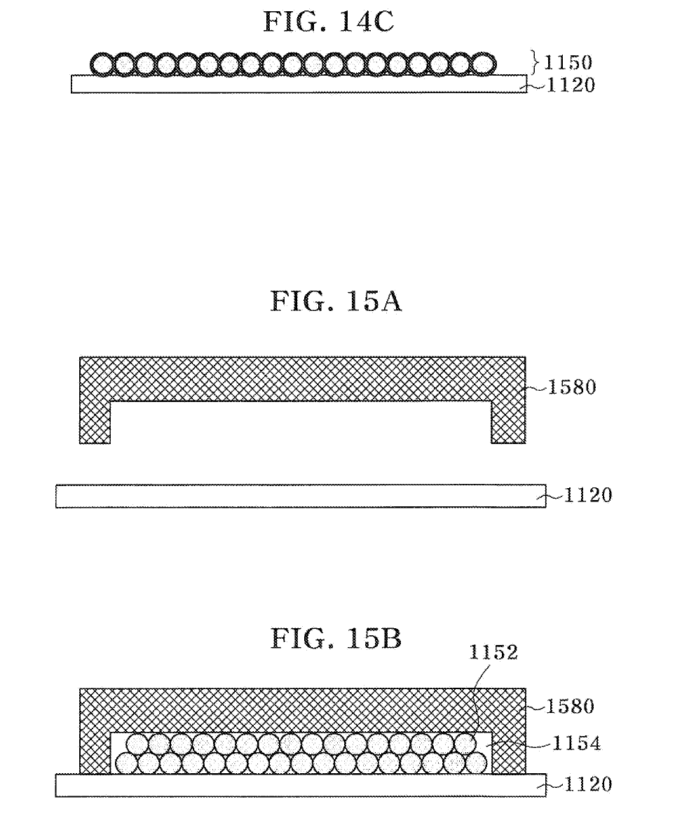

FIG. 14 is a view illustrating a process of forming at least one phosphor layer 1150 on a substrate 1120 according to another exemplary embodiment.

Referring to FIG. 14A, surface treatment is performed on a surface of a phosphor 1152 using a functional group 1490. The functional group 1490 may have both a hydrophilic group 1492 and a hydrophobic group 1494. A functional group 1490 having the hydrophilic group 1492 attached to a surface of the phosphor 1152 and the hydrophobic group 1494 attached to the hydrophilic group 1492 is illustrated as an example of the functional group 1490 in the drawing. In another exemplary embodiment, unlike the illustrated drawing, the functional group 1490 may be shaped into various forms.

Referring to FIG. 14B, the phosphor 1152 on which the surface treatment is performed using the functional group 1490 is floated in the solution 1410 using interaction between a hydrophilic molecule and a hydrophobic molecule. A polar or non-polar solution may be used as the solution 1410. An example of the polar solution may include water. An example of the non-polar solution may include an organic solvent. The example is for the purpose of understanding and is not intended to exclude possible use of various kinds of polar or non-polar solutions other than the above example. When a surface area of the solution 1410 on which the phosphors 1152 whose surfaces are treated using the functional group 1490 are floated is adjusted, a Langmuir-Blodgett film 1450 may be obtained as illustrated in the drawing.

Referring to FIG. 14C, the at least one phosphor layer 1150 is formed on the substrate 1120 using the Langmuir-Blodgett film 1450 of FIG. 14B. For example, when a predetermined pressure is applied to the Langmuir-Blodgett film 1450 using the substrate 1120, the Langmuir-Blodgett film 1450 moves toward the substrate 1120. As a result, the at least one phosphor layer 1150 may be formed on the substrate 1120. When the above process is repeated, the height of the phosphor layer 1150 formed on a surface of the substrate 1120 may be adjusted by hydrophobic-hydrophobic bonds or hydrophilic-hydrophilic bonds.

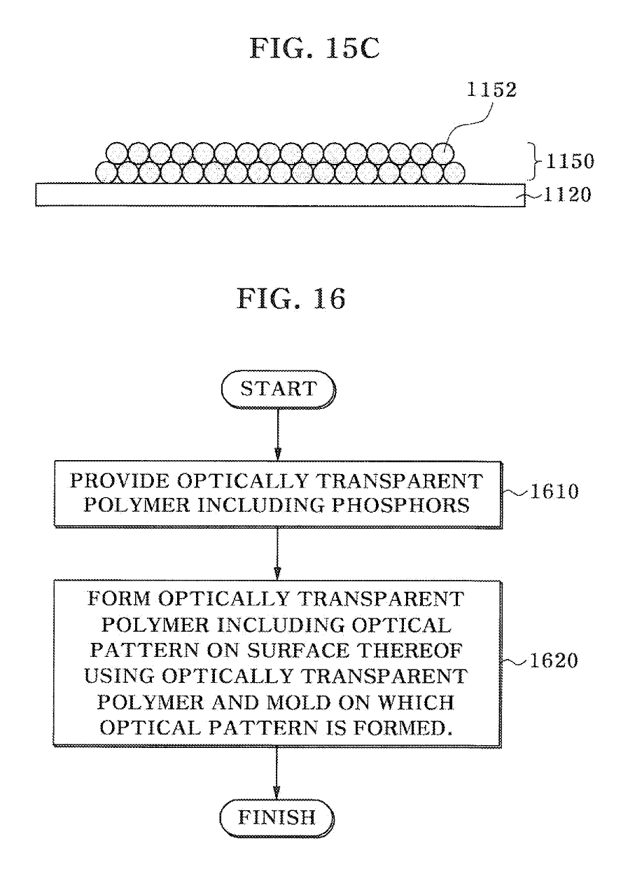

FIG. 15 is a view illustrating a process of forming at least one phosphor layer 1150 on a substrate 1120 according to still another exemplary embodiment.

Referring to FIG. 15A, the substrate 1120 and a template 1580 are prepared. A recess is formed on a surface of the template 1580. When the substrate 1120 and the template 1580 are combined, a space may be formed between the substrate 1120 and the template 1580.

Referring to FIG. 15B, a polymer 1154 in which phosphors 1152 are dispersed is formed in the space. The polymer 1154 including the dispersed phosphors 1152 and formed in the space may be formed by combining the substrate 1120 with the template 1580, and then injecting the polymer 1154 in which the phosphors 1152 are dispersed. Alternatively, the polymer 1154 including the dispersed phosphors 1152 and formed in the space may be formed by disposing the polymer 154 in which the phosphors 1152 are dispersed on the substrate 1120 and applying a pressure by the template 1580.

Referring to FIG. 15C, when the template 1580 is removed, the at least one phosphor layer 1150 may be obtained on the substrate 1120. When the height of the recess is adjusted, the height of the phosphor layer 1150 may be adjusted. The at least one phosphor layer 1150 formed on the surface of the substrate 1120 is illustrated as an example in the drawing. In another exemplary embodiment, unlike the illustrated drawing, an optically transparent polymer film (not shown) in which the phosphors are dispersed may be formed on the substrate 1120. The optically transparent polymer film in which the phosphors are dispersed may be obtained by adjusting the height of the recess. Alternatively, it may be obtained by adjusting a concentration of the phosphors 1152 dispersed in the polymer 1154.

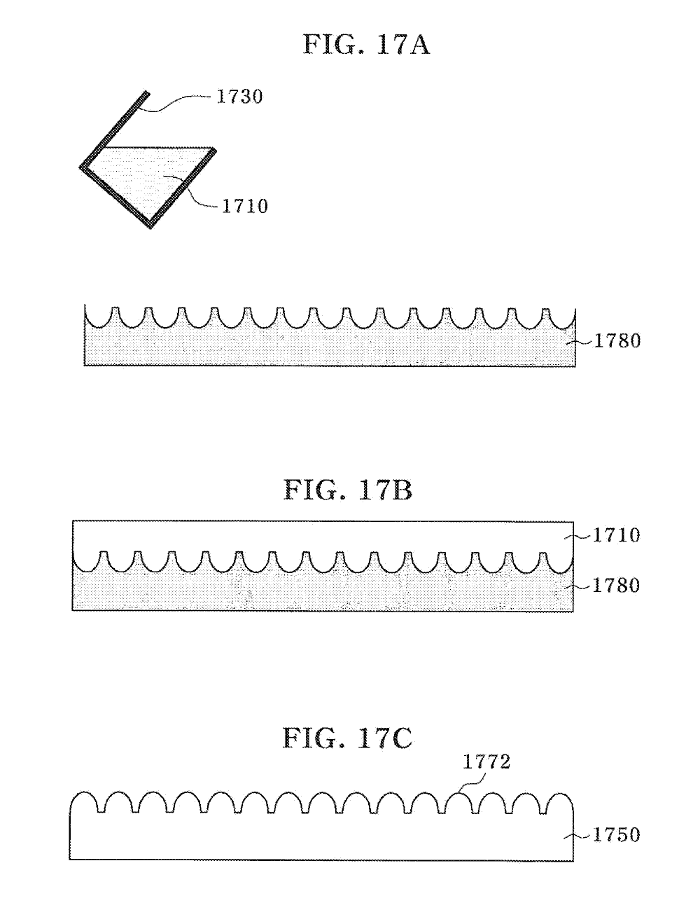

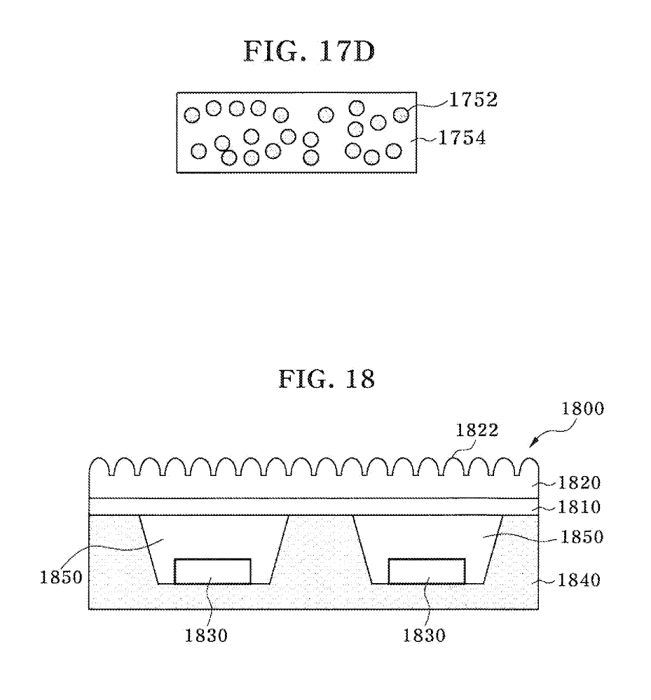

FIG. 16 is a flowchart illustrating a method of fabricating a composite film used for a light emitting apparatus including a light emitting device according to yet another exemplary embodiment. Referring to FIG. 16, a method of fabricating a composite film begins at block 1610. In block 1610, an optically transparent polymer including phosphors is provided. In block 1620, the optically transparent polymer and a mold on which an optical pattern is formed is used to form an optically transparent polymer film on which the optical pattern is formed on a surface thereof. The optical pattern diffuses, reduces or mixes at least one of light emitted by the light emitting device, light emitted by the phosphors and a combination thereof. A method of fabricating a composite film used for a light emitting apparatus including a light emitting device according to yet another exemplary embodiment will be described below with reference to FIG. 17.

FIG. 17 is a view illustrating a method of fabricating a composite film used for a light emitting apparatus including a light emitting device according to yet another exemplary embodiment.

Referring to FIG. 17A, a container 1730 receiving an optically transparent polymer 1710 in which phosphors are dispersed and a mold 1780 on which an optical pattern 1772 is engraved are prepared. The optically transparent polymer 1710 may be a photo or thermally cured polymer. Various kinds of materials may be employed as the mold 1780. An example of the mold 1780 may include a polymer film on which the optical pattern 1772 is engraved. The optical pattern 1772 may diffuse, reduce or mix at least one of light emitted by the light emitting device, light emitted by the phosphors and a combination thereof.

Referring to FIG. 17B, the mold 1780 is filled with the optically transparent polymer 1710 in which the phosphors are dispersed. The optically transparent polymer 1710 may be cured in various manners. For example, the optically transparent polymer 1710 may be cured by UV light to form an optically transparent polymer film 1750. As another example, the optically transparent polymer 1710 may be thermally cured to form the optically transparent polymer film 1750.

Referring to FIG. 17C, the optically transparent polymer film 1750 is separated from the mold 1780. An optical pattern 1772 formed on a surface of the optically transparent polymer film 1750.

Referring to FIG. 17D, the optically transparent polymer film 1750 includes phosphors 1752 and a cured optically transparent polymer 1754. Since the phosphors 1752 are substantially the same as the phosphors 212 described with reference to FIG. 2, the detailed description thereof will be omitted for convenience.

FIG. 18 is a view of a light emitting apparatus according to one exemplary embodiment. Referring to FIG. 18, a light emitting apparatus 1800 includes at least one light emitting device 1830, a substrate 1840 and a composite film 1820. In some exemplary embodiments, the light emitting apparatus 1800 may optionally further include an optically transparent polymer film 1810 or a filler 1850.

Various types of substrates may be employed as the substrate 1840. An example of the substrate 1840 may include a semiconductor substrate (e.g., a silicon substrate), a glass substrate, a plastic substrate, a circuit board (e.g., a printed circuit board (PCB)), a low temperature co-fired ceramic (LTCC) substrate or a metal substrate. An example of the metal substrate may include a lead frame. The lead frame refers to a metal substrate that functions as both a lead connecting a semiconductor chip to an external circuit and a frame fixing a semiconductor package to an electronic circuit board. A semiconductor substrate having a recess is illustrated as an example of the substrate 1840 in the drawing. In another exemplary embodiment, unlike the illustrated drawing, a lead frame may be used as the substrate 1840.

The at least one light emitting device 1830 is disposed on a surface of the substrate 1840. A light emitting device 1830 disposed in the recess of the substrate 1840 is illustrated as an example in the drawing. Various kinds of light emitting devices may be used as the light emitting device 1830. An example of the light emitting device 1830 may include one selected from an LED, an OLED, a diode laser, a semiconductor laser, a resonant cavity LED, a super luminescent LED and a combination thereof. The example is for the purpose of understanding and various light emitting devices may be used as the light emitting device 1830. In one exemplary embodiment, an LED may be used as the light emitting device 1830. The LED may be classified depending on a type and color of emitted light, used materials, etc. The LED may be classified as a top emission LED or a side emission LED depending on a type of emitted light. In addition, the LED may be a blue LED, a red LED, a green LED, a yellow LED or a UV LED depending on a color of emitted light. Further, the LED may be a GaP:ZnO LED, a GaP:N LED, a GaAs-based LED, a GaAsP-based LED, a GaAlAs-based LED, an InGaAlP-based LED, a GaN-based LED, a SiC-based LED or a Group II-VI LED depending on used materials. The light emitting apparatus 1800 including one light emitting device 1830 disposed in the recess is illustrated as an example in the drawing. In another exemplary embodiment, unlike the illustrated drawing, a plurality of light emitting devices (not shown) may be disposed in the recess. For example, the plurality of light emitting devices may emit light of the same color. As another example, at least two light emitting devices of the plurality of light emitting devices may emit light of different colors.

The composite film 1820 is disposed to be spaced apart from the light emitting device 1830, and includes phosphors (not shown) and an optical pattern 1822. The optical pattern 1822 diffuses, reduces or mixes at least one of light emitted by the light emitting device, light emitted by the phosphor and a combination thereof. In one exemplary embodiment, the composite film 1820 may include a fluorescent layer including phosphors and an optical plate disposed on the fluorescent layer and including the optical pattern 1822 formed on a surface thereof as the composite film 110 described with reference to FIG. 1. In another exemplary embodiment, the composite film 1820 may include an optically transparent polymer film including phosphors as the composite film 900 described with reference to FIG. 9. The optical pattern 1822 is formed on a surface of the polymer film. An optically transparent polymer film including the phosphors formed on a surface of the optical pattern 1822 is illustrated as an example of the composite film 1820 in the drawing. In another exemplary embodiment, unlike the illustrated drawing, the composite films 100, 700, 800, and 900 described with reference to FIGS. 1 to 9 may be used as the composite film. Also, the composite film 1820 that is disposed such that the optical pattern 1822 faces upwardly is illustrated as an example in the drawing. In still another exemplary embodiment, unlike the illustrated drawing, the composite film 1820 may be disposed to be upside down such that the optical pattern 1822 faces the light emitting device 1830.

The optically transparent polymer film 1810 may be disposed between the light emitting device 1830 and the composite film 1820. An example of the optically transparent polymer film 1810 may include a cured polymer paste. The optically transparent polymer film 1810 may be used to bond the substrate 1840 to the composite film 1820. Also, the optically transparent polymer film 1810 may be used for reflective index matching such that light emitted from the light emitting device 1830 is well transmitted to the optical pattern 1822. When the bonding and reflective index matching functions are not required, the optically transparent polymer film 1810 may be omitted.

The filler 1850 may be disposed on at least a part of a surface of the light emitting device 1830. A partial region of the surface of the light emitting device 1830, which is required for electrical contact, may not be covered with the filler 1850.

Various materials may be used as the filler 1850. An example of the filler 1850 may include a cured optically transparent polymer paste. The filler 1850 may be used for bonding the substrate 1840 to the composite film 1820. Also, the filler 1850 may be used for refractive index matching such that light emitted from the light emitting device 1830 is well transmitted to the optical pattern 1822. When the bonding and reflective index matching functions are not required, the filler 1850 may be omitted. In addition, in the process of fabricating the light emitting apparatus 1800, the filler 1850 may function to protect the light emitting device 1830. When the protection, bonding and reflective index matching functions are not required, the filler 1850 may be omitted.

Referring again to FIG. 18, the light emitting apparatus 1800 includes the substrate 1840 including the at least one light emitting device 1830 disposed on a surface thereof and the composite film 1820. As described with reference to FIG. 1, the light emitting apparatus 1800 may provide light of various color temperatures or colors by changing the type of the phosphors included in the composite film 1820 and the color of the light emitting device 1830. In one exemplary embodiment, when a UV LED is used as the light emitting device 1830, and a composite film 1820 including red phosphors is used as the composite film 1820, the light emitting apparatus 1800 providing red light may be implemented. In another exemplary embodiment, when a UV LED is used as the light emitting device 1830, and a composite film 1820 including red phosphors, green phosphors and blue phosphors is used as the composite film 1820, the light emitting apparatus 1800 providing white light may be implemented. In this case, as a result of adjusting a density of each of the red phosphors, the green phosphors and the blue phosphors, the color temperature of the light emitting apparatus 1800 may be adjusted. The example is for the purpose of understanding, and various colors or color temperatures other than the above example may be implemented.

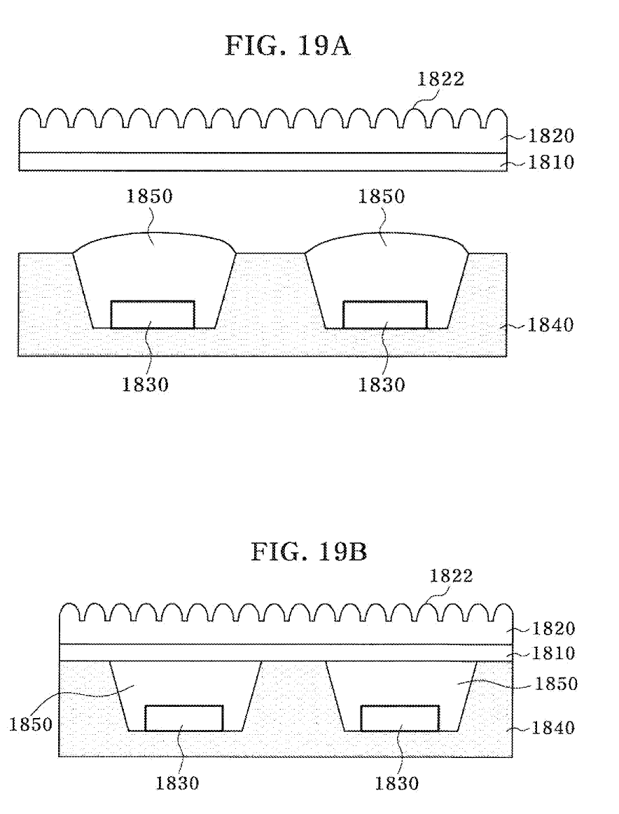

FIG. 19 is a view illustrating a method of fabricating a light emitting apparatus according to one exemplary embodiment.

Referring to FIG. 19A, a substrate 1840 in which at least one light emitting device 1830 is disposed and a composite film 1820 are provided. In some exemplary embodiments, a filler 1850 may be optionally disposed on at least a part of a surface of the light emitting device 1830. In other exemplary embodiments, an optically transparent polymer film 1810 may be optionally disposed on a surface of the composite film 1820.

Referring to FIG. 19B, the substrate 1840 and the composite film 1820 are combined to fabricate a light emitting apparatus. In the drawing, a case in which the substrate 1840 is combined with the composite film 1820 using the optically transparent polymer film 1810 and the filler 1850 is illustrated as an example. In one exemplary embodiment, the substrate 1840 may be combined with the composite film 1820 by curing the optically transparent polymer film 1810 and the filler 1850. A method of curing the optically transparent polymer film 1810 and the filler 1850 may include photo or thermal curing. In another exemplary embodiment, unlike the illustrated drawing, the substrate 1840 may be combined with the composite film 1820 using the filler 1850. In this case, the optically transparent polymer film 1810 may be omitted. In still another exemplary embodiment, unlike the illustrated drawing, the substrate 1840 may be combined with the composite film 1820 using the optically transparent polymer film 1810. In this case, the filler 1850 may be omitted.

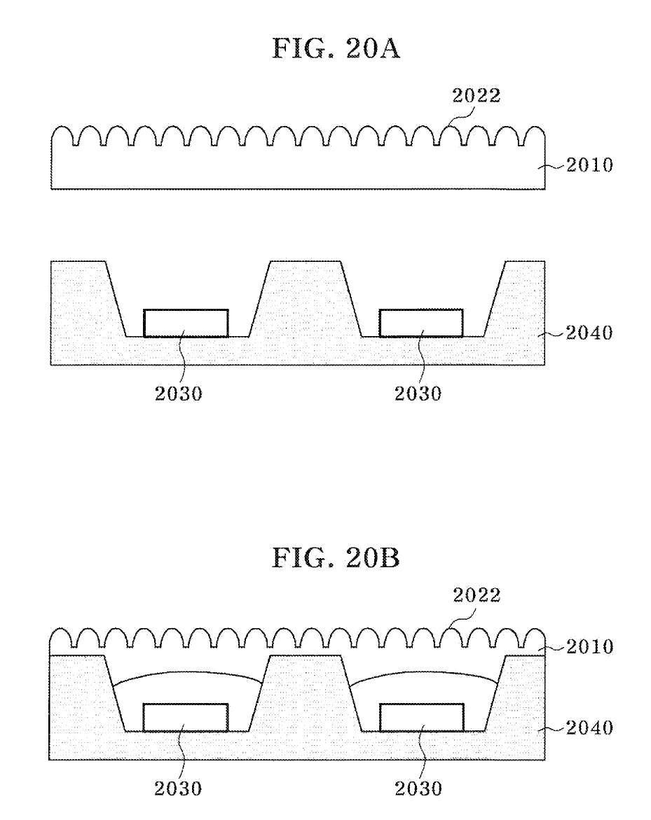

FIG. 20 is a view illustrating a method of fabricating a light emitting apparatus according to another exemplary embodiment.

Referring to FIG. 20A, a substrate 2040 in which at least one light emitting device 2030 is disposed and a composite film 2020 are provided. An optical pattern 2022 is formed on a surface of the composite film 2020. Since the disposition and structure of the composite film 2020 are substantially the same as those of the composite film 1820 described with reference to FIGS. 18 and 19, the detailed description thereof will be omitted for convenience. At least a part of the composite film 2020 may not be cured. A composite film 2020 including a region that faces the substrate 2040 and is not cured is illustrated as an example in the drawing. Since the light emitting device 2030, the substrate 2040 and the optical pattern 2022 are substantially the same as the light emitting device 1830, the substrate 1840 and the optical pattern 1822 described with reference to FIGS. 18 and 19, the detailed description thereof will be omitted for convenience.

Referring to FIG. 20B, the substrate 2040 and the composite film 2020 are combined to fabricate a light emitting apparatus. A case in which the substrate 2040 is combined with the composite film 2020 using the part of the composite film 2020, which is not cured, is illustrated as an example in the drawing. The part of the composite film 2020 that is not cured may be photo or thermally cured. When heat or light is applied after the substrate 2040 is combined with the composite film 2020, a light emitting apparatus may be fabricated. A case in which a space between the light emitting device 2030 and the composite film 2020 is empty is illustrated as an example. hi another exemplary embodiment, unlike the illustrated drawing, the space between the light emitting device 2030 and the composite film 2020 may be filled with a filler (not shown). Since the material and function of the filler are substantially the same as those of the filler 1850 described with reference to FIGS. 18 and 19, the detailed description thereof will be omitted.

Referring again to FIGS. 19 and 20, the method of fabricating a light emitting apparatus by combining each substrate 1840 and 2040 including the at least one light emitting device 1830 and 2030 disposed therein with each composite film 1820 and 2020 is illustrated in each of the drawings. That is, a process of fabricating the light emitting apparatus is separately performed from a process of fabricating each of the composite films 1820 and 2020. The composite film may be fabricated in various manners. For example, the composite film may be fabricated using a semiconductor batch process. In this case, even composite films fabricated using the same process may exhibit different characteristics depending on location. That is, a problem of uniformity may occur. When the process of fabricating the composite films 1820 and 2020 is separated from that of fabricating a light emitting apparatus, the composite films 1820 and 2020 exhibiting necessary characteristics may be selected to be used for fabricating the light emitting apparatus. As a result, yield in fabricating a light emitting apparatus may be improved.

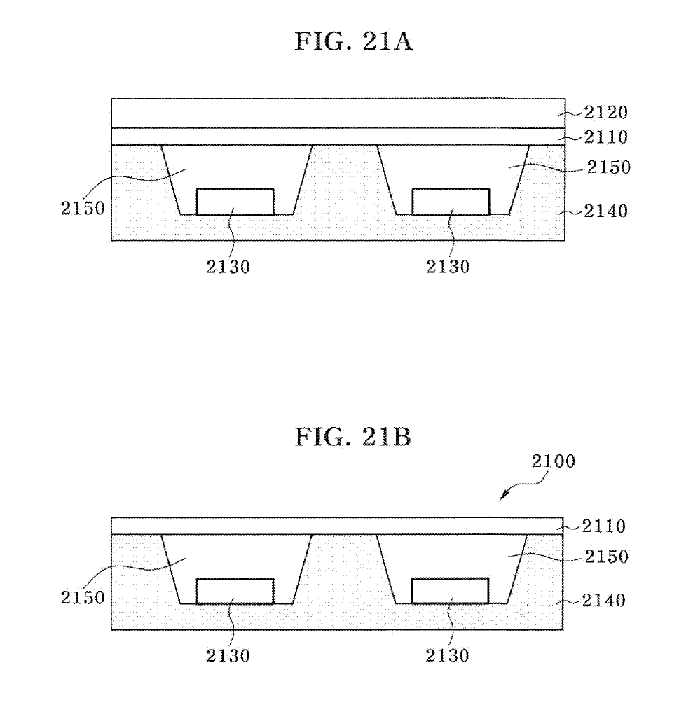

FIG. 21 is a view illustrating a method of fabricating a light emitting apparatus according to still another exemplary embodiment.

Referring to FIG. 21A, a substrate 2140 in which at least one light emitting device 2130 is disposed and a fluorescent layer 2110 are prepared. For an example, an optically transparent polymer film 2120 is disposed on a fluorescent layer 2110. As another example, the fluorescent layer 2110 may be disposed on a flexible substrate.

The example is for the purpose of understanding and the fluorescent layer 2110 may be disposed on various substrates. The fluorescent layer 2110 and the optically transparent polymer film 2120 may be combined with the substrate 2140 using the method described with reference to FIGS. 19 and 20. The optically transparent polymer film 2120 may function to protect the fluorescent layer 2110 in the process of disposing the fluorescent layer 2110 on the substrate 2140.

Referring to FIG. 21B, the optically transparent polymer film 2120 is separated from the fluorescent layer 2110. As a result, the fluorescent layer 2110 may be formed on the substrate 2140. The fluorescent layer 2110 may have substantially the same characteristics as the fluorescent layer 110 described with reference to FIGS. 1 to 6. A light emitting apparatus having various colors or color temperatures may be obtained using the light emitting device 2130 and the fluorescent layer 2110.

A method of fabricating a light emitting apparatus according to still another exemplary embodiment may further include a process (not shown) of forming an optical pattern on the fluorescent layer 2110. The process of forming the optical pattern may be performed after the process of FIG. 21B. As a result, a light emitting apparatus having the fluorescent layer 2110 and the optical pattern may be fabricated. In one exemplary embodiment, a film (not shown) having an optical pattern may be attached on the fluorescent layer 2110 to fabricate the light emitting apparatus. In another exemplary embodiment, a surface of the fluorescent layer 2110 may be processed to form an optical pattern, so that a light emitting apparatus may be fabricated. The process of fabricating a light emitting apparatus may result in improved yield as described with reference to FIGS. 19 and 20.

Since the light emitting device 2130 and the substrate 2140 are substantially the same as the light emitting device 2130 and the substrate 2140 described with reference to FIGS. 18 and 19, the detailed description thereof will be omitted for convenience. Since the fluorescent layer 2110 is substantially the same as the fluorescent layer 110 described with reference to FIG. 1, the detailed description thereof will be omitted for convenience.

While the invention has been shown and described with reference to certain exemplary embodiments thereof, it will be understood by those skilled in the art that various changes in form and details may be made therein without departing from the spirit and scope of the invention as defined by the appended claims.

1. A composite film used for a light emitting apparatus including a light emitting device, the composite film comprising:
a fluorescent layer including phosphors; and
an optical plate disposed on the fluorescent layer, and diffusing, reducing or mixing at least one of light emitted by the light emitting device, light emitted by the phosphors and a combination thereof.

2. The composite film of claim 1, wherein the fluorescent layer includes at least one phosphor layer.

3. The composite film of claim 2, wherein the fluorescent layer further includes at least one optically transparent polymer film.

4. The composite film of claim 1, wherein the fluorescent layer includes at least one optically transparent polymer film in which the phosphors are dispersed.

5. The composite film of claim 4, wherein the fluorescent layer further includes at least one optically transparent polymer film.

6. The composite film of claim 1, wherein the phosphors include at least one selected from a red phosphor, a green phosphor, a blue phosphor, a yellow phosphor and a combination thereof.

7. The composite film of claim 1, wherein the optical plate includes an optical pattern disposed on a surface thereof, and the optical pattern includes at least one selected from at least one convex lens, at least one concave lens and a combination thereof.

8. A method of fabricating a composite film used for a light emitting apparatus including a light emitting device, the method comprising:
providing a fluorescent layer including phosphors; and
forming an optical pattern diffusing, reducing or mixing at least one of light emitted by the light emitting device, light emitted by the phosphors and a combination thereof on a surface of the fluorescent layer.

9. The method of fabricating a composite film of claim 8, wherein the fluorescent layer includes an optically transparent polymer film on which at least one phosphor layer is formed on the surface thereof or an optically transparent polymer film in which phosphors are dispersed in providing the fluorescent layer.

10. The method of fabricating a composite film of claim 8, wherein providing the fluorescent layer includes:
providing a solution in which the phosphors are dispersed and a substrate;
forming at least one phosphor layer on the substrate using at least one of dip coating, sedimentation, Langmuir-Blodgett deposition, template coating and a combination thereof; and
casting an optically transparent polymer on the phosphor layer.

11. The method of fabricating a composite film of claim 8, wherein providing the fluorescent layer includes:
providing a solution in which the phosphors are dispersed and an optically transparent polymer film; and
forming at least one phosphor layer on the optically transparent polymer film using at least one of dip coating, sedimentation, Langmuir-Blodgett deposition, template coating and a combination thereof.

12. The method of fabricating a composite film of claim 8, wherein forming the optical pattern includes forming an optical plate on the surface of the fluorescent layer, the optical pattern being formed on a surface of the optical plate.

13. The method of fabricating a composite film of claim 8, wherein forming the optical pattern includes forming the optical pattern on the surface of the fluorescent layer using a mold.

14. A light emitting apparatus comprising:
a substrate including at least one light emitting device disposed on a surface thereof; and
a composite film disposed to be spaced apart from the light emitting device, and including phosphors and an optical pattern, wherein the optical pattern diffuses, reduces or mixes at least one of light emitted by the light emitting device, light emitted by the phosphors and a combination thereof.

15. The light emitting apparatus of claim 14, wherein the composite film comprises:
a fluorescent layer including the phosphors; and
an optical plate disposed on the fluorescent layer, and including the optical pattern formed on a surface thereof.

16. The light emitting apparatus of claim 15, wherein the fluorescent layer includes at least one phosphor layer.

17. The light emitting apparatus of claim 16, wherein the phosphor layer includes at least one selected from a red phosphor, a green phosphor, a blue phosphor, a yellow phosphor and a combination thereof.

18. The light emitting apparatus of claim 14, wherein the composite film includes an optically transparent polymer film including phosphors, the polymer film including the optical pattern formed on a surface thereof.
